(19) United States
(12) Patent Application Publication
(10) Pub. No.: US 2003/0172094 A1
(43) Pub. Date: Sep. 11, 2003

(54) Automatic file system maintenance

(75) Inventors: Giampaolo Lauria, Fishkill, NY (US); Anthony F. Pioli, Rhinebeck, NY (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, ARMONK, NY

(21) Appl. No.: 10/092,321

(22) Filed: Mar. 6, 2002

(51) Int. Cl. G06F 12/00

(52) U.S. Cl. 707/206

(57) ABSTRACT

A system, method and computer program product are provided for automatically maintaining a file system maintenance. Files are selected from the file system for deletion so as to achieve a predetermined usage level for the file system, and the files that were selected are deleted. The selection and the deletion are performed automatically according to a maintenance schedule. In a preferred embodiment, for the selection, the files are sorted using a sorting algorithm to produce a sorted list of files, and files are selected beginning at the top of the sorted list until deletion of the selected files would achieve the predetermined usage level for the file system. A system for automatically maintaining a file system is also provided.

### BACKGROUND OF THE INVENTION

1. Field of the Invention

The present invention relates to the field of file systems and, more specifically, file system maintenance.

2. Description of Related Art

File systems require maintenance in order to operate at optimal levels. One aspect of file system maintenance that requires constant attention is free disk space. Free (or unused) disk space can be used for a variety of purposes by the computer system housing the file system. Web related files are saved temporarily to free disk space in order to speed up later recall of those files. Calculation data is temporarily saved to free disk space when RAM resources are full. Also, disk operations such as de-fragmentation use any free disk space as a holding area while rearranging data. As such, free disk space is an important resource that is necessary for the efficient operation of a computer system. Because free disk space is used by numerous routines on a computer at once, however, free disk space can often be a scarce commodity.

One conventional approach to maintaining free disk space has been to maintain the file system by hand. That is, the user or administrator of a file system searches through the file system, chooses files for deletion and deletes them to increase free disk space. One way of doing this is to manually find the oldest files in the file system and delete enough of them to acquire the amount of free disk space that is needed or desired. Another way of doing this is to manually find the largest files in the file system and delete enough of them to acquire the amount of free disk space that is needed or desired. These approaches, however, are time-consuming and tedious.

Another conventional approach has been to use file system maintenance programs. Current file system maintenance programs are typically executed at the user's request and simply delete a group of files identified by the user. These file system maintenance programs may also recommend certain directories for deletion, such as the directory for holding temporary Internet files. One drawback to these current approaches is the amount of user interaction required in identifying and confirming files for deletion.

Accordingly, there exists a need for a system that effectively maintains free disk space while requiring little or no user interaction.

### SUMMARY OF THE INVENTION

It is an object of the present invention to overcome the above-mentioned drawbacks and to provide a system, method and computer program product for facilitating file system maintenance. One embodiment of the present invention provides a method for automatically maintaining a file system maintenance. According to the method, files are selected from the file system for deletion so as to achieve a predetermined usage level for the file system, and the files that were selected are deleted. The selection and the deletion are performed automatically according to a maintenance schedule. In a preferred embodiment, for the selection, the files are sorted using a sorting algorithm to produce a sorted list of files, and files are selected beginning at the top of the sorted list until deletion of the selected files would achieve the predetermined usage level for the file system. A system for automatically maintaining a file system is also provided.

Another object of the present invention is to provide automatic file system maintenance. This reduces the amount of user interaction necessary and the amount of user time consumed.

Yet another object of the present invention is to provide numerous maintenance options. This is advantageous as it increases the customizability of the system, and thus, the user-friendliness of the system.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating the overall system architecture of an embodiment of the present invention.

FIG. 2 is a block diagram illustrating the file system maintenance options in one embodiment of the present invention.

FIG. 3 is a flowchart depicting the operation and control flow according to one embodiment of the present invention.

FIG. 4 is a flowchart depicting the operation and control flow of the file selection process according to one embodiment of the present invention.

FIG. 5 is an illustration of a maintenance schedule graphical user interface according to one embodiment of the present invention.

FIG. 6 is an illustration of a usage goal graphical user interface according to one embodiment of the present invention.

FIG. 7 is a block diagram of an exemplary computer system useful for implementing the present invention.

### DETAILED DESCRIPTION OF PREFERRED EMBODIMENTS

1. Overview of the System

The present invention is described in terms of preferred embodiments below. This is for convenience only and is not intended to limit the application of the present invention. In fact, after reading the following description, it will be apparent to one of ordinary skill in the relevant art(s) how to implement the present invention in alternative embodiments.

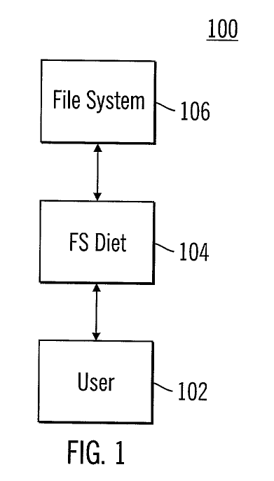

FIG. 1 is a block diagram illustrating the overall system architecture of an embodiment of the present invention. FIG. 1 is a generalized embodiment of the present invention. FIG. 1 represents the resident program model of the present invention in which the present invention is a resident computer program on the computer system it will maintain. An alternative model of the present invention, the network model, is described in detail below.

System 100 includes a user 102, a file system 106 and a computer program 104 for performing file system maintenance. Computer program 104 is also referred to as the File System Diet (FSDiet) computer program. FSDiet 104 can be implemented in hardware, software, or a combination of the two. User 102 is a person that is interfacing with the overall computer system of which system 100 is a part. User 102 interacts with FSDiet 104 via an interface. The interface can be a Graphical User Interface (GUI), a command line interface, a voice interface, or any other interface. Exemplary GUIs for FSDiet 104 are described in greater detail below.

In one embodiment of the present invention, the overall computer system is a PC (e.g., an IBM™ or compatible PC workstation running the Microsoft® Windows operating system, Macintosh computer running the Mac® OS operating system, or the like), a PDA, a game console or any other processing device used with a file system. In another embodiment of the present invention, the overall computer system is a server such as one or more SUN Ultra workstations running the SunOS™ operating system. In yet another embodiment of the present invention, the overall computer system is one or more IBM™ or compatible personal computer (PC) workstations running either the Windows operating system or the BSD Unix operating system. In yet another embodiment of the present invention, the overall computer system is a mainframe computer system.

File system 106 is a collection of files and directories that are stored on one or more internal hard disks, external hard disks, floppy disks, RAM disks or disk partitions of any drive.

In another embodiment of the present invention, system 100 can be represented by the network model. In the network model, system 100 is not a part of one computer system, but rather a plurality of computer systems distributed over a network. In such an embodiment, user 102, file system 106 and computer program 104 can be distributed over a network. For example, user 102 and file system 106 can be located on one computer and FSDiet 104 can be located remotely on another computer but remaining accessible to user 102 via a network. In one embodiment of the present invention, the network can be a circuit switched network, such as the Public Service Telephone Network (PSTN) 114. In another embodiment of the present invention, the network can be a packet switched network. The packet switched network can be a wide area network (WAN) such as the global Internet, a private WAN, a local area network (LAN), a telecommunications network or any combination of networks.

It should be understood that the particular embodiments of system 100, shown in FIG. 1 are for illustrative purposes only and are not meant to limit the present invention. For example, while a single user is shown for ease of explanation, it will be apparent to one skilled in the relevant art(s) that system 100 can support more than one user.

2. Maintenance Options

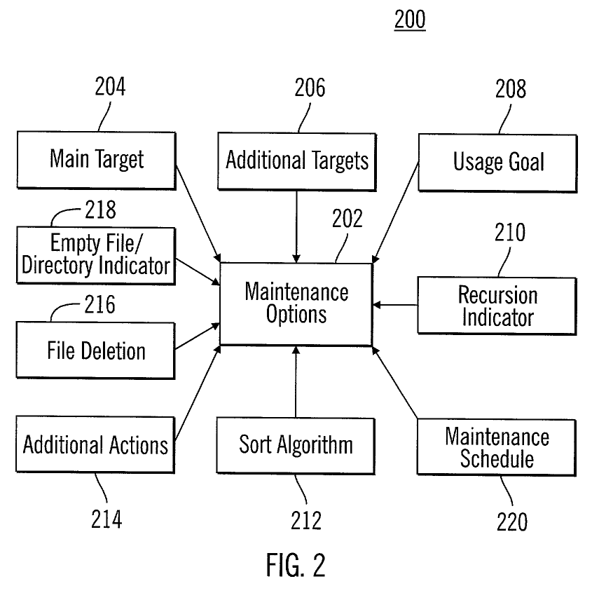

FIG. 2 is a block diagram 200 illustrating file system maintenance options according to one embodiment of the present invention. FIG. 2 shows the various components that constitute the file system maintenance options 202 offered by an exemplary embodiment of FSDiet 104. User 102 can define maintenance options 202 via an interface, such as the exemplary GUI described in greater detail below.

The main target 204 defines the file system or portion of a file system that user 102 desires to maintain. Main target 204 can be one or more entire disks (e.g., an internal hard disk, an external hard disk, a floppy disk, or a RAM disk) or a disk partition of any drive. Main target 204 can also be a directory, a group of directories or a group of files.

Additional targets 206 define any additional portions of the file system that user 102 desires to maintain. Additional targets 206 are typically individual files and directories that are not covered by main target 204. For example, additional targets 206 can be any file in the entire file system that matches particular search criteria such as a file name, a file size, a file creation time or a file owner. Regular Boolean expressions can be used with FSDiet to find files whose file names satisfy a particular pattern. In one example, a user defines internal hard disk drive C: as the main target and defines all files older than a predetermined date and all files larger than a predetermined size as additional targets 206.

Usage goal 208 defines the file system usage level (i.e., amount of free disk space) that user 102 desires to attain. Usage goal 208 can be a percentage or an amount to which usage of the target should be reduced. For example, one usage goal can is “reduce usage to 60% of the target”. In this example, usage of the target is reduced until 40% of the target is free disk space. In another example, a usage goal is “reduce usage to 50 Gigabytes.” In this example, usage of the target is reduced until the total usage of the target is 50 GB and the rest of the target is maintained as free disk space. Usage goal 208 can also be a percentage or an amount by which usage of the target should be reduced. For example, one usage goal is “delete 33% of existing files”. In this example, 33% of existing files are deleted. In another example, a usage goal is “delete 50 Gigabytes of existing files.” In this example, 50 GB of existing files are deleted.

Recursion indicator 210 defines whether file system maintenance shall be recursive. That is, recursion indicator 210 defines whether sub-directories shall be traversed when file maintenance occurs. For example, if drive C: contains the following three sub-directories: \dirA, \dirB, and \dirC, and directory C: is defined by user 102 as the main target 204, then recursion indicator 210 defines whether the sub-directories \dirA, \dirB, \dirC are subject to the file system maintenance defined by user 102. Recursion indicator 210 is either a positive or a negative indicator.

Sort algorithm 212 defines how files are sorted before files are selected for deletion. When file system maintenance is performed, all files in the main target 204 are first sorted by a particular attribute. Then, files are selected for deletion from the top of the list until the usage goal 208 is achieved. The file selection routine is described in greater detail below. Sort algorithm 212 can be an algorithm that sorts files in the main target 204 by increasing file size, decreasing file size, increasing file creation date, decreasing file creation date, file owner or file group. The sort algorithm 212 creates a sorted list of all files in the main target 204. This list is then used to select files for deletion. In preferred embodiments of the present invention, the sort algorithm 212 also includes the files in the additional targets 206 when sorting files.

Additional actions 214 define additional actions to perform on the files selected for deletion. In one embodiment of the present invention, possible additional actions 214 that can be selected include displaying the names of the selected files on the computer screen, prompting the user to confirm deletion of the files, or backing up the selected files to another file system. In another embodiment of the present invention, possible additional actions 214 include the execution of any operating system command such as a “move” command, which is used for moving files. In another embodiment of the present invention, possible additional actions 214 include the execution of another computer program.

File deletion 216 defines how file deletion shall take place. In one embodiment of the present invention, file deletion 216 can be the simple deletion of a file, such as the execution of a DOS “delete” command to simply delete a file. However, in another embodiment of the present invention, file deletion 216 can define more complex deletion operations such as the execution of a computer program which deletes any residual trace of a file, such as in a file backup or a file allocation table of the system.

Empty file/directory indicator 218 defines whether or not empty files and empty directories are deleted during file deletion 216. Empty files and directories do not affect the calculation of file system usage, and it may be desirous to keep certain empty files or directories because they may act as placeholders for computer programs. Thus, it is not necessary to delete empty files or directories during file deletion 216 in order to attain the usage goal 208. Empty file/directory indicator 218 can be either a positive or a negative indicator.

Maintenance schedule 220 defines when file system maintenance shall occur. User 102 can specify that file system maintenance is to occur only once, at certain defined times in the future, periodically for a specified period or continuously. If user 102 chooses to perform file system maintenance periodically, user 102 can preferably choose a period such as hourly, daily, weekly, monthly, or yearly. If user 102 chooses to perform file system maintenance continuously, file system maintenance is performed on a rolling basis as the computer system operates. If user 102 chooses any maintenance schedule 220 in the future, file system maintenance is performed automatically by FSDiet 104 at the specified time(s). In one embodiment of the present invention, user 102 is prompted to confirm the execution file system maintenance that is scheduled to be performed automatically. Thus, before FSDiet 104 performs previously scheduled maintenance, in this embodiment it prompts user 102 to confirm the action. This feature is helpful in the event that performance of the scheduled maintenance may interfere with a program currently being executed by user 102.

3. Operation of the System

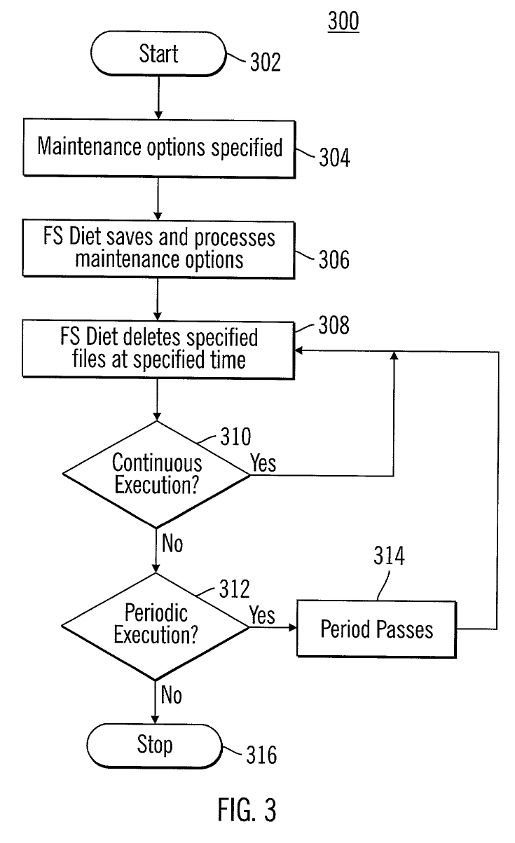

FIG. 3 is a flowchart depicting the operation and control flow 300 in one embodiment of the present invention. FIG. 3 generally shows the operation of system 100. Control flow 300 begins with step 302 and flows directly to step 304.

In step 304, user 102 specifies to FSDiet 104 the maintenance options 202 that are desired. User 102 submits to FSDiet 104 the maintenance options 202 via an interface such as a GUI. In step 306, FSDiet 104 saves and processes the maintenance options 202. In one embodiment, FSDiet 104 saves the maintenance options 202 in a file.

In step 308, FSDiet 104 performs the scheduled file system maintenance at the specified time. In one embodiment, the file system maintenance comprises three steps: (1) sorting of files in the target, (2) selection of files for deletion, and (3) deletion of the selected files. File sorting is described in greater detail below. Once files in the target are sorted, files are selected starting from the top of the list and continuing down the list. File selection ends when enough files have been selected to achieve the usage goal 208. When file selection is completed, the selected files are deleted. Alternatively, files can be selected from the top of the list and deleted one-by-one until the desired usage level is achieved. In preferred embodiments of the present invention, the target in these sorting and deleting procedures includes the additional targets 206 along with the main target 204.

In step 310, FSDiet 104 determines whether file system maintenance has been scheduled to be performed continuously. If the result of the determination is positive, control flows back to step 308. Subsequently, control flows continuously between step 308 and step 310. If the result of the determination is negative, control flows to step 312. In step 312, FSDiet 104 determines whether file system maintenance has been scheduled to be performed periodically or again at a specific time in the future. If the result of the determination is positive, control flows to step 314. In step 314, FSDiet 104 waits for the specified period to pass before file system maintenance occurs again. Subsequently, control flows periodically between steps 308-314. If the result of the determination is negative, control flows to step 316. In step 316, control flow 300 ceases.

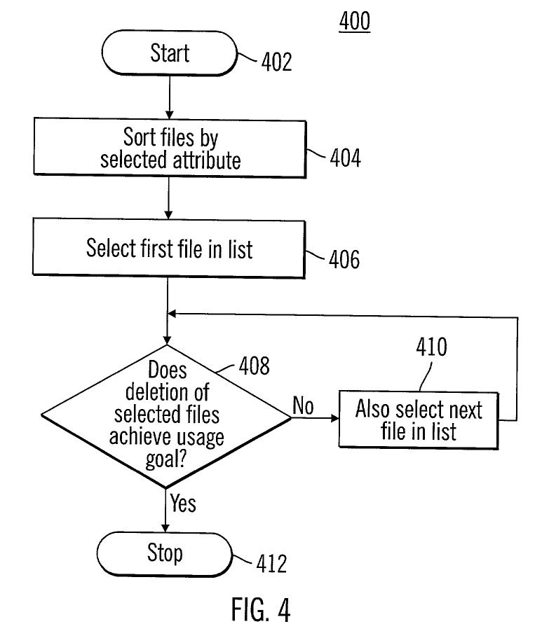

FIG. 4 is a flowchart depicting the operation and control flow 400 of the file selection process in one embodiment of the present invention. FIG. 4 describes in greater detail the file sorting process used in step 308 (see FIG. 3). Control flow 400 begins with step 402 and flows directly to step 404.

In step 404, FSDiet 104 sorts all files in the target by selected attribute such as file size or file date. As explained above, the target preferably includes the main target 204 and the additional targets 206. In step 406, FSDiet 104 selects for deletion the first file in the sorted list. In step 408, FSDiet 104 determines whether the usage goal 208 is achieved by deletion of the selected file(s). If the result of this determination is negative, control flows to step 410. If the result of this determination is affirmative, control flows to step 412. In step 410, FSDiet 104 also selects for deletion the next file in the sorted list. In step 412, control flow 414 ceases.

As explained above, the file deletion process follows control flow 400. File deletion is performed by FSDiet 104 according to the file deletion 216 options specified by user 102.

4. Interfaces

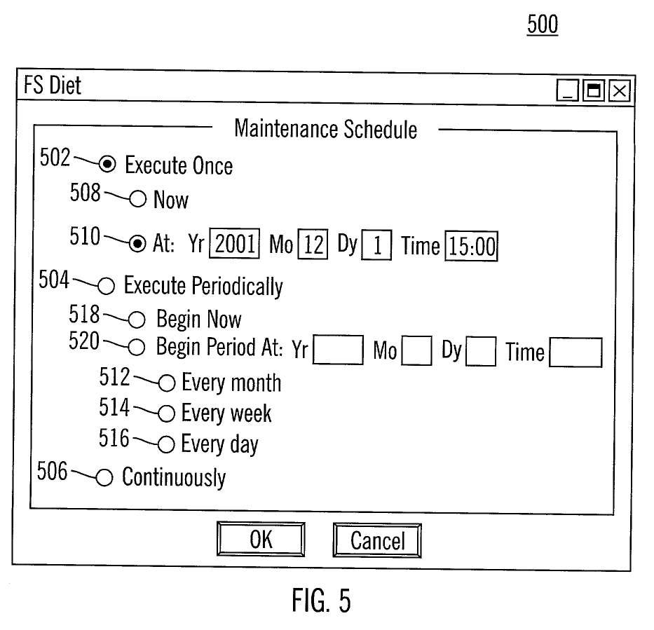

FIG. 5 is an illustration of a maintenance schedule GUI 500 in one embodiment of the present invention. FIG. 5 is an exemplary illustration of an interface that may be used to enter maintenance schedule 220 options into FSDiet 104. GUI 500 shows three major maintenance schedule 220 options for user 102: execution only once, periodic execution and continuous execution. Each selection has a radio button (502, 504, and 506 respectively) associated with it. As such, only one of the three options can be selected at any time. There are two other buttons at the bottom of the GUI. These buttons (“OK” and “Cancel”) are for confirmation by user 102 of the entered maintenance schedule 220 options.

GUI 500 shows that the first major option (execute once) for the maintenance schedule has two further options associated with it: execution now and execution at a later defined time. These two further selections also have radio buttons associated with them (508 and 510, respectively). The selection for execution at a later time has several text fields associated with it. These text fields allow user 102 to define a time in the future for execution of the file system maintenance.

GUI 500 shows that the second major option (execute periodically) has a first set of further options associated with it: begin the period now and begin the period at a later time. These selections also have radio buttons associated with them (518 and 520, respectively). The selection for beginning the period now simply begins the period at the time of user input. The selection for beginning the period at a later time begins the period at the future time specified by user 102. The selection for beginning the period at a later time has several text fields associated with it. These text fields allow user 102 to define a time in the future for beginning the period. GUI 500 shows that the second major option (execute periodically) has a second set of further options associated with it: monthly, weekly and daily. These selections also have radio buttons associated with them (512, 514 and 516, respectively).

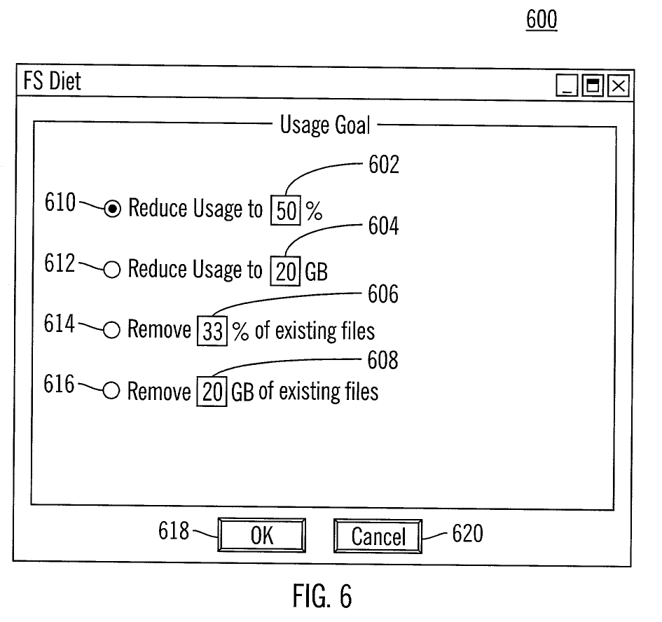

FIG. 6 is an illustration of a usage goal GUI 600, in one embodiment of the present invention. FIG. 6 is an exemplary illustration of an interface that may be used to enter usage goal 208 options into FSDiet 104. GUI 500 shows four usage goal 208 options for user 102. Each selection has a radio button (610, 612, 614 and 616) associated with it. As such, only one of the four options can be selected at any time. There are two other buttons at the bottom of the GUI. These buttons (“OK” and “Cancel”) are for confirmation by user 102 of the entered usage goal 208 options.

The first option 610 allows user 102 to enter a desired percentage of total usage of the target. Text field 602 allows user 102 to enter a desired percentage of total usage of the target. The second option 612 allows user 102 to enter a desired amount of total usage of the target. Text field 604 allows user 102 to enter a desired amount of total usage of the target. The third option 614 allows user 102 to enter a percentage by which to reduce current usage of the target. Text field 606 allows user 102 to enter the percentage by which the current usage of the target shall be reduced. The fourth option 616 allows user 102 to enter an amount by which to reduce current usage of the target. Text field 608 allows user 102 to enter the amount by which the current usage of the target shall be reduced.

Accordingly, preferred embodiments of the present invention provide a customizable automatic file system maintenance system. The automatic nature of the file system maintenance allows file system maintenance to perform the task of freeing space with little or no required interaction from the user. This reduces user error and the amount of user time consumed. Another advantage of the present invention is the availability of numerous maintenance options. As described above, the user can specify a variety of options regarding file system maintenance such as the time of the maintenance, the areas to maintain and the manner in which to maintain the area. This allows for increased and more detailed control over the file system maintenance process. This also increases the customizability of the system, and thus, the user-friendliness of the system.

5. Exemplary Implementations

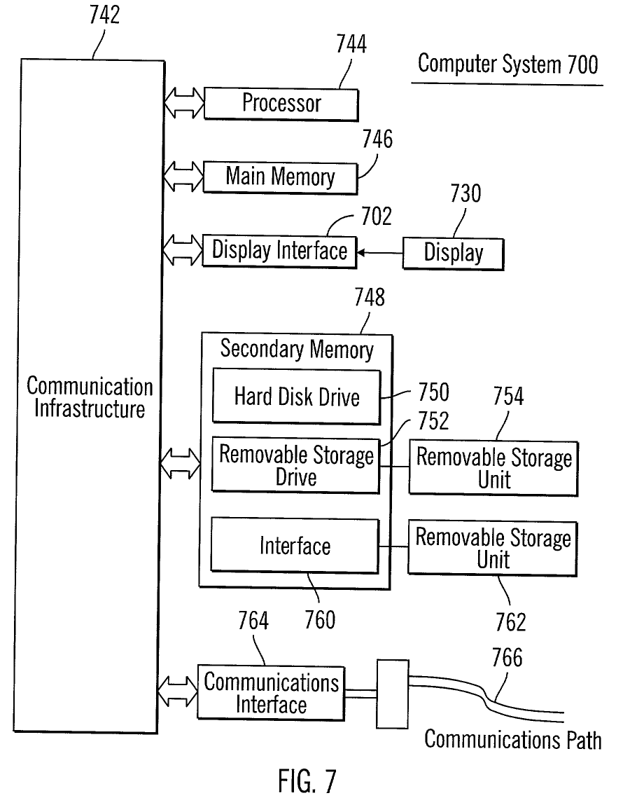

The present invention (e.g., system 100, flow 300, flow 400 or any part thereof) may be implemented using hardware, software or a combination thereof, and may be implemented in one or more computer systems or other processing systems. An example of such a computer system 700 is shown in FIG. 7. The computer system 700 represents any single or multi-processor computer. In conjunction, single-threaded and multithreaded applications can be used. Unified or distributed memory systems can be used. Computer system 700, or portions thereof, may be used to implement the present invention. For example, the system 100 of the present invention may comprise software running on a computer system such as computer system 700.

In one example, system 100 of the present invention is implemented in a multi-platform (platform independent) programming language such as JAVA™, programming language/structured query language (PL/SQL), hyper-text mark-up language (HTML), practical extraction report language (PERL), Flash programming language, common gateway interface/structured query language (CGI/SQL) or the like. Java™-enabled and JavaScript™-enabled browsers can be used, such as, Netscape™, HotJava™, and Microsoft™ Explorer™ browsers. Active content Web pages can be used. Such active content Web pages can include Java™ applets or ActiveX™ controls, or any other active content technology developed now or in the future. The present invention, however, is not intended to be limited to Java™, JavaScript™, or their enabled browsers, and can be implemented in any programming language developed now or in the future.

In another example, system 100 of the present invention, may be implemented using a high-level programming language (e.g., C++) and applications written for the Microsoft Windows™ or SUN™ OS environments. It will be apparent to a person of ordinary skill in the relevant art(s) how to implement the present invention in alternative embodiments from the teachings herein.

Computer system 700 includes one or more processors, such as processor 744. One or more processors 744 can execute software implementing the routines described above, such as shown in FIG. 3 and FIG. 4. Each processor 744 is connected to a communication infrastructure 742 (e.g., a communications bus, cross-bar, or network). Various software embodiments are described in terms of this exemplary computer system. In further embodiments, the present invention is implemented using other computer systems and/or computer architectures.

Computer system 700 can include a display interface 702 that forwards graphics, text, and other data from the communication infrastructure 742 (or from a frame buffer) for display on the display unit 730.

Computer system 700 also includes a main memory 746, preferably random access memory (RAM), and can also include a secondary memory 748. The secondary memory 748 can include, for example, a hard disk drive 750 and/or a removable storage drive 752 (such as a floppy disk drive, a magnetic tape drive, an optical disk drive, or the like). The removable storage drive 752 reads from and/or writes to a removable storage unit 754 in a conventional manner. Removable storage unit 754 represents a floppy disk, magnetic tape, optical disk, or the like, which is read by and written to by removable storage drive 752. The removable storage unit 754 includes a computer usable storage medium having stored therein computer software and/or data.

In alternative embodiments, secondary memory 748 may include other similar means for allowing computer programs or other instructions to be loaded into computer system 700. Such means can include, for example, a removable storage unit 762 and an interface 760. Examples can include a program cartridge and cartridge interface (such as that found in video game console devices), a removable memory chip (such as an EPROM, or PROM) and associated socket, and other removable storage units 762 and interfaces 760 which allow software and data to be transferred from the removable storage unit 762 to computer system 700.

Computer system 700 can also include a communications interface 764. Communications interface 764 allows software and data to be transferred between computer system 700 and external devices via communications path 766. Examples of communications interface 764 can include a modem, a network interface (such as Ethernet card), a communications port, interfaces described above, etc. Software and data transferred via communications interface 764 are in the form of signals which can be electronic, electromagnetic, optical or other signals capable of being received by communications interface 764, via communications path 766. Note that communications interface 764 provides a means by which computer system 700 can interface to a network such as the Internet.

The present invention can be implemented using software executing in an environment similar to that described above with respect to FIG. 3 and FIG. 4. The term “computer program product” includes a removable storage unit 754, a hard disk installed in hard disk drive 750, or a carrier wave carrying software over a communication path 766 (wireless link or cable) to communication interface 764. A “computer useable medium” can include magnetic media, optical media, semiconductor memory or other recordable media, or media that transmits a carrier wave or other signal. These computer program products are means for providing software to computer system 700.

Computer programs (also called computer control logic) are stored in main memory 746 and/or secondary memory 748. Computer programs can also be received via communications interface 764. Such computer programs, when executed, enable the computer system 700 to perform the features of the present invention as discussed herein. In particular, the computer programs, when executed, enable the processor 744 to perform features of the present invention. Accordingly, such computer programs represent controllers of the computer system 700.

The present invention can be implemented as control logic in software, firmware, hardware or any combination thereof. In an embodiment where the invention is implemented using software, the software may be stored in a computer program product and loaded into computer system 700 using removable storage drive 752, hard disk drive 750, or interface 760. Alternatively, the computer program product may be downloaded to computer system 700 over communications path 766. The control logic (software), when executed by the one or more processors 744, causes the processor(s) 744 to perform functions of the invention as described herein.

In another embodiment, the invention is implemented primarily in firmware and/or hardware using, for example, hardware components such as application specific integrated circuits (ASICs). A hardware state machine is implemented so as to perform the functions described herein.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A method for automatically maintaining a file system, said method comprising the steps of:
selecting files from the file system for deletion so as to achieve a predetermined usage level for the file system; and
deleting the files that were selected,
wherein the selecting step and the deleting step are performed automatically according to a maintenance schedule.

2. The method of claim 1, wherein the selecting step includes the sub-steps of:
sorting the files using a sorting algorithm to produce a sorted list of files; and
selecting files beginning at the top of the sorted list until deletion of the selected files would achieve the predetermined usage level for the file system.

3. The method of claim 2, wherein the sorting algorithm sorts files by file date or file size.

4. The method of claim 1, wherein the predetermined usage level specifies a percentage of usage of the file system or an amount of usage of the file system.

5. The method of claim 1, wherein the predetermined usage level specifies a percentage by which to reduce usage of the file system or an amount to reduce usage of the file system.

6. The method of claim 1, further comprising the step of receiving the predetermined usage level from a user.

7. The method of claim 6, further comprising the step of:
receiving a selection of a main target from the user, the main target identifying a portion of the file system that is to be maintained,
wherein the selecting step and the deleting step are performed on the main target.

8. The method of claim 7, further comprising the step of:
receiving a selection of at least one additional target from the user, each additional target identifying another portion of the file system that is to be maintained,
wherein the selecting step and the deleting step are also performed on the additional target.

9. The method of claim 1, further comprising the step of receiving the maintenance schedule from a user.

10. The method of claim 9, wherein the maintenance schedule specifies that the selecting step and the deleting step are performed automatically at a defined periodic interval or at a plurality of defined times in the future.

11. A machine-readable medium encoded with a program for automatically maintaining a file system, said program containing instructions for performing the steps of:
selecting files from the file system for deletion so as to achieve a predetermined usage level for the file system; and
deleting the files that were selected,
wherein the selecting step and the deleting step are performed automatically according to a maintenance schedule.

12. The machine-readable medium of claim 11, wherein the selecting step includes the sub-steps of:
sorting the files using a sorting algorithm to produce a sorted list of files; and
selecting files beginning at the top of the sorted list until deletion of the selected files would achieve the predetermined usage level for the file system.

13. The machine-readable medium of claim 11, wherein the predetermined usage level specifies a percentage of usage of the file system, an amount of usage of the file system, a percentage by which to reduce usage of the file system, or an amount to reduce usage of the file system.

14. The machine-readable medium of claim 13, wherein said program further contains instructions for performing the step of receiving the predetermined usage level from a user.

15. The machine-readable medium of claim 14, wherein said program further contains instructions for performing the step of:
receiving a selection of a main target from the user, the main target identifying a portion of the file system that is to be maintained,
wherein the selecting step and the deleting step are performed on the main target.

16. The machine-readable medium of claim 14, wherein said program further contains instructions for performing the step of receiving the maintenance schedule from the user.

17. The machine-readable medium of claim 16, wherein the maintenance schedule specifies that the selecting step and the deleting step are performed automatically at a defined periodic interval or at a plurality of defined times in the future.

18. A system for automatically maintaining a file system, said system comprising:
a file selector for selecting files from the file system for deletion so as to achieve a predetermined usage level for the file system; and
a file remover for deleting the files that were selected,
wherein the file selector and the file remover automatically operate according to a maintenance schedule.

19. The system of claim 18, wherein the file selector sorts the files using a sorting algorithm to produce a sorted list of files, and selects files beginning at the top of the sorted list until deletion of the selected files would achieve the predetermined usage level for the file system.

20. The system of claim 18, wherein the predetermined usage level specifies a percentage of usage of the file system, an amount of usage of the file system, a percentage by which to reduce usage of the file system, or an amount to reduce usage of the file system.

21. The system of claim 20, further comprising a user interface for receiving the predetermined usage level from a user.

22. The system of claim 21,
wherein the user interface also receives a selection of a main target from the user, the main target identifying a portion of the file system that is to be maintained, and
the file selector and the file remover operate on the main target.

23. The system of claim 21, wherein the user interface also receives the maintenance schedule from the user.
